(19) United States
(12) Patent Application Publication
(10) Pub. No.: US 2017/0351200 A1
(43) Pub. Date: Dec. 7, 2017

(54) IMAGE FORMING APPARATUS

(71) Applicant: CANON KABUSHIKI KAISHA, Tokyo (JP)

(72) Inventor: Kenta Matsuzaki, Noda-shi (JP)

(21) Appl. No.: 15/602,403

(22) Filed: May 23, 2017

(30) Foreign Application Priority Data
Jun. 3, 2016 (JP) 2016-111921

(51) Int. Cl. G03G 15/16

(52) U.S. Cl. CPC G03G 15/168; G03G 15/1615

(57) ABSTRACT

A power supply is configured to apply voltage to a power feed roller. An elastic blade of a roller cleaning unit clean a surface of the power feed roller at a position different from an abutting position of the power feed roller and a secondary transfer outer roller. A control unit is configured to execute a secondary transfer cleaning mode at a timing when a transfer of a toner image in a secondary transfer portion is not performed. In the secondary transfer cleaning mode, a voltage of only one of the positive and negative polarities is applied to the power feed roller while the secondary transfer outer roller and the power feed roller are rotated.

### BACKGROUND OF THE INVENTION

### Field of the Invention

The present invention relates to an image forming apparatus such as a copier, a printer, a facsimile, and a multi-functional printer having multiple functions of these apparatuses.

### Description of the Related Art

Conventionally, there is a known image forming apparatus with an intermediate transfer system in which a toner image formed on a photosensitive drum is primarily transferred to an intermediate transfer belt as an image bearing member and the toner image is then secondarily transferred from the intermediate transfer belt to a recording material. A transfer roller, i.e., a secondary transfer outer roller, abutting against an outer peripheral surface of the intermediate transfer belt is disposed at a secondary transfer portion in which the toner image is secondarily transferred onto the recording material, and the secondary transfer is performed by applying a transfer voltage to the transfer roller.

The transfer roller includes an elastic layer provided on an outer circumferential surface of a conductive shaft portion, and conductive agent such as an ion conductive agent is dispersed in the elastic layer to impart conductivity. Therefore, when an application time of a voltage to the transfer roller is increased by use, ions in the ion conductive agent are polarized so as to be biased to one side of a roller surface side (outside) and a shaft portion side (inside), and electric resistance tends to increase. Japanese Patent Laid-Open No. 2005-316200 has proposed such a configuration to suppress an increase in the electric resistance caused by polarization that a voltage is applied from a power feed roller, which serves as a rotary power feed member and disposed in contact with the surface of the transfer roller, to the transfer roller, and a toner image is transferred from an intermediate transfer belt to a recording material.

However, in the case of the configuration of the above-described document, if the toner adheres to the transfer roller from the intermediate transfer belt, the toner may also adhere to the power feed roller in contact with the transfer roller. When the toner adheres to the power feed roller, there is a possibility that unevenness of a current flowing from the power feed roller to the transfer roller occurs. In addition, there is a case where the toner adhered to the power feed roller re-adheres to the transfer roller to contaminate the recording material.

Therefore, it is conceivable to electrostatically clean the toner adhered to the power feed roller by applying a voltage of the same polarity as the toner to the power feed roller. In this case, however, since the toner is transferred from the power feed roller to the transfer roller, the transfer roller should also be cleaned to suppress re-adhesion of the toner to the recording material. As a result, when electrostatically cleaning the power feed roller, a cleaning time may be longer than when simply cleaning the transfer roller.

### SUMMARY OF THE INVENTION

According to one aspect of the present invention, an image forming apparatus includes an image bearing member provided movable and configured to bear a toner image, a transfer roller including a conductive shaft portion and an outer portion which is formed on an outer circumference of the shaft portion and which contains conductive agent, the transfer roller forming a transfer portion in which the toner image borne on the image bearing member is transferred to a recording material, a rotary power feed member disposed in contact with the transfer roller and configured to feed a current to the transfer roller, a power supply configured to apply voltage to the rotary power feed member, a cleaning member disposed in contact with the rotary power feed member and configured to clean a surface of the rotary power feed member along with a rotation of the rotary power feed member, and an execution unit configured to execute a cleaning mode in a period other than a period during which the toner image of the image bearing member is transferred to the recording material in the transfer portion, the power supply applying only a cleaning voltage to the rotary power feed member while the image bearing member is moved and the transfer roller and the rotary power feed member are rotated in the cleaning mode, a polarity of the cleaning voltage being the same polarity as a normal charge polarity of toner.

According to another aspect of the present invention, an image forming apparatus includes an image bearing member provided movable and configured to bear a toner image, a transfer roller including a conductive shaft portion and an outer portion which is formed on an outer circumference of the shaft portion and which contains conductive agent, the transfer roller forming a transfer portion in which the toner image borne on the image bearing member is transferred to a recording material, a rotary power feed member disposed in contact with the transfer roller and configured to feed a current to the transfer roller, a power supply configured to apply voltage to the rotary power feed member, a cleaning member disposed in contact with the rotary power feed member and configured to clean a surface of the rotary power feed member along with a rotation of the rotary power feed member, and an execution unit configured to execute a cleaning mode in a period other than a period during which the toner image of the image bearing member is transferred to the recording material in the transfer portion, the power supply applying only a cleaning voltage to the rotary power feed member while the image bearing member is moved and the transfer roller and the rotary power feed member are rotated in the cleaning mode, a polarity of the cleaning voltage being an opposite polarity to a normal charge polarity of toner.

Further features of the present invention will become apparent from the following description of exemplary embodiments with reference to the attached drawings.

### BRIEF DESCRIPTION OF THE DRAWINGS

FIG. 1 is a schematic diagram illustrating a configuration of an image forming apparatus according to a first embodiment.

FIG. 2 is a schematic diagram illustrating a cleaning configuration of a power feed roller according to the first embodiment.

FIG. 3 is a control block diagram of a secondary transfer bias according to the first embodiment.

FIG. 4A is a schematic diagram illustrating a configuration of a secondary transfer portion according to a comparative example in a state upon a start of cleaning.

FIG. 4B illustrates the comparative example in a state after a half rotation of a secondary transfer outer roller.

FIG. 4C illustrates the comparative example in a state after one rotation of the secondary transfer outer roller

FIG. 4D illustrates the comparative example in a state after one rotation of a power feed roller in addition to one rotation of the secondary transfer outer roller.

FIG. 5 is a diagram illustrating a relationship between a cleaning voltage and an application time of the cleaning voltage in the first embodiment and the comparative example.

FIG. 6 is a diagram illustrating a distribution of toner adhered to a secondary transfer outer roller and the power feed roller.

FIG. 7 is a schematic diagram illustrating a cleaning configuration of a power feed roller according to a second embodiment.

### DESCRIPTION OF THE EMBODIMENTS

Now, embodiments of the present disclosure will be described with reference to the attached drawings.

### First Embodiment

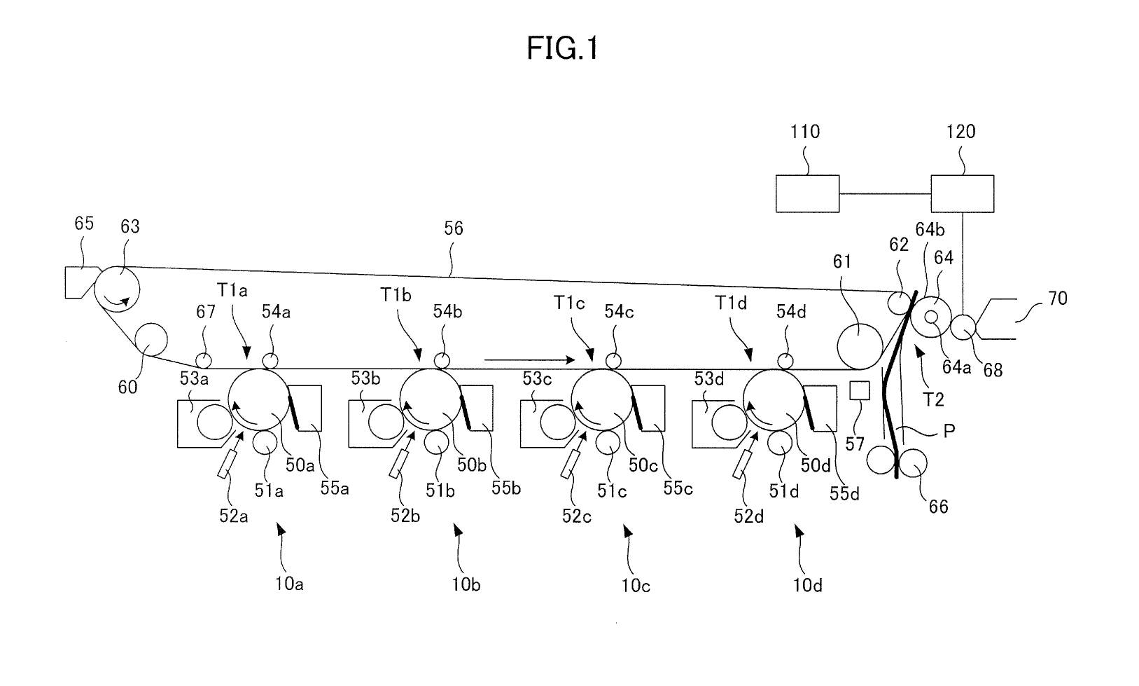

A first embodiment will be described with reference to FIGS. 1 to 6. First, a schematic configuration of an image forming apparatus of the present embodiment will be described with reference to FIG. 1. Image Forming Apparatus

An image forming apparatus 100 is a so-called tandem type intermediate transfer full color printer in which a plurality of image forming portions 10a, 10b, 10c, and 10d are arranged along a direction of rotation (direction of movement) of an intermediate transfer belt 56. Such an image forming apparatus 100 forms a full color image on a recording material S such as a sheet (paper, OHP sheet, or the like) using an electrophotographic method in accordance with an image signal transmitted from an external device such as a personal computer, an image signal from a document reading device, or the like.

The image forming portions 10a, 10b, 10c, and 10d respectively have the photosensitive drums 50a, 50b, 50c, and 50d that rotate in directions of arrows of FIG. 1. Surfaces of the photosensitive drums 50a, 50b, 50c, and 50d are respectively charged by charging rollers 51a, 51b, 51c, and 51d. Electrostatic latent images are formed on the charged photosensitive drums 50a, 50b, 50c, and 50d by exposing units 52a, 52b, 52c, and 52d. The electrostatic latent images on the photosensitive drums 50a, 50b, 50c, and 50d are respectively visualized as toner images by developing units 53a, 53b, 53c, and 53d containing toners of respective color components. In the present embodiment, the developing units 53a, 53b, 53c, and 53d respectively use a two-component developer including nonmagnetic toner and carrier having magnetism, and a normal charge polarity of the toner is negative. It is noted that it is also possible to use a one-component developer.

Primary transfer rollers 54a, 54b, 54c, and 54d are disposed at positions facing the photosensitive drums 50a, 50b, 50c, and 50d with the intermediate transfer belt is interposed therebetween, and respectively configure primary transfer portions T1a, T1b, T1c, and T1d. A primary transfer bias is applied to the primary transfer rollers 54a, 54b, 54c, and 54d and thereby the toner images of respective colors formed on the photosensitive drums 50a, 50b, 50c, and 50d are successively superimposed, and are primarily transferred on the intermediate transfer belt 56. The toner remaining on the photosensitive drums 50a, 50b, 50c, and 50d after the primary transfer is removed by drum cleaning units 55a, 55b, 55c, and 55d. The image forming portions 10a, 10b, 10c, and 10d are disposed in the order of yellow (Y), magenta (M), cyan (C), and black (K) from upstream to downstream in the rotation direction of the intermediate transfer belt 56.

Meanwhile, the recording material S accommodated in a recording material storage cassette (not illustrated) is conveyed from a supply roller 66 to a secondary transfer portion T2 in accordance with a timing of a toner image forming. Then, a secondary transfer bias is applied to the secondary transfer portion T2 and thereby the toner images having been superimposed and transferred on the intermediate transfer belt 56 are collectively transferred (secondarily transferred) in the secondary transfer portion T2. Detailed configurations of the secondary transfer portion T2 will be described later. The toner or paper dust remaining on the intermediate transfer belt 56 without being transferred to the secondary transfer portion T2 is removed by a belt cleaning unit 65.

The belt cleaning unit 65, which serves as an image-bearing-member cleaning member, is disposed at a position downstream of the secondary transfer portion T2 and upstream of the most upstream primary transfer portion T1a, i.e., that of the image forming portion 10a, with respect to the direction of rotation of the intermediate transfer belt, so as to face a tension roller 63. The belt cleaning unit includes a blade abutting against the intermediate transfer belt 56 at this position and the surface of the intermediate transfer belt 56 is cleaned as the intermediate transfer belt moves.

Next, the recording material S is conveyed to a fixing unit (not illustrated). The toner on the recording material S is melted and mixed by being heated and pressed in the fixing unit and is fixed to the recording material S as a full color image. Thereafter, the recording material S is discharged out of the apparatus. In this manner, a sequential image forming process is completed. An operation of each unit is controlled by a control unit 110, which serves as an execution unit. Intermediate Transfer Belt

The intermediate transfer belt 56, which is an example of an image bearing member, is an endless belt of film and rotates (moves) while carrying the toner image primarily transferred from each of the photosensitive drums 50a, 50b, 50c, and 50d. Such an intermediate transfer belt 56 is made of a resin such as polyimide or polyamide or an alloy thereof, or one which is obtained by containing an antistatic agent such as carbon black in various rubbers or the like in an appropriate amount. Therefore, it is formed to have a surface resistivity of 1×109 to 5×1013 ohms per square and a thickness thereof is, for example, approximately 0.04 to 0.5 mm.

The intermediate transfer belt 56 is stretched by idler rollers 60, 61, and 67, the tension roller 63, and a secondary transfer inner roller 62. The tension roller 63 applies a tension of, for example, approximately 3 to 12 kilogram-forces (about 29 to 118 N) to the intermediate transfer belt 56. The secondary transfer inner roller 62 is rotationally driven by a motor (not illustrated) to rotate the intermediate transfer belt 56 at a predetermined speed.

### Primary Transfer Roller

The primary transfer rollers 54a, 54b, 54c, and 54d are provided inside the intermediate transfer belt 56, and the material thereof is formed of a metal roller such as sulfur and sulfur compound free cutting steel (SUM) or stainless steel (SUS). A voltage (primary transfer bias) of an opposite polarity to a normal charge polarity of the toner is applied to the primary transfer rollers 54a, 54b, 54c, and 54d. Therefore, a primary transfer contrast, which is a potential difference between surface potentials of the photosensitive drums 50a, 50b, 50c, and 50d, and potentials of the primary transfer rollers 54a, 54b, 54c, and 54d, is formed. A predetermined primary transfer contrast is formed in each of the primary transfer portions T1a to T1d. Therefore, the toner images of the photosensitive drums 50a to 50d are electrostatically attracted to the intermediate transfer belt 56 respectively and sequentially, and the toner images superimposed on the intermediate transfer belt 56 are formed. Moreover, the primary transfer rollers 54a, 54b, 54c, and 54d have a straight shape in a thrust direction and a roller diameter is approximately 6 to 10 mm.

### Secondary Transfer Portion

The secondary transfer portion T2 is formed by a secondary transfer outer roller 64, which is an example of a transfer roller, abutting against a toner image bearing surface (outer circumferential surface) of the intermediate transfer belt 56. More specifically, the secondary transfer inner roller 62 is disposed so as to nip the intermediate transfer belt 56 with the secondary transfer outer roller 64, and the intermediate transfer belt 56 and the secondary transfer outer roller 64 form a nip portion at which the recording material is nipped. Therefore, the toner image is transferred from the intermediate transfer belt 56 onto the recording material passing through the nip portion.

In addition, a current is supplied from a power feed roller 68, which serves as a rotary power feed member, to the secondary transfer outer roller 64 to transfer the toner image from the intermediate transfer belt 56 to the recording material. That is, the power feed roller 68 is configured to rotate while being in contact with the secondary transfer outer roller 64 at a position different from the secondary transfer portion T2, and is capable of feeding the current to the secondary transfer outer roller so as to transfer the toner image at the secondary transfer portion T2. The power feed roller 68A is configured to be applied a voltage from a high voltage power supply 120, i.e., a power supply.

Here, the secondary transfer inner roller 62 is formed by providing ethylene/propylene/diene rubber (EPDM) around a metal core. The secondary transfer inner roller is formed so that a roller diameter is 20 mm and a rubber thickness is 0.5 mm, and the hardness is set to, for example, 70° in Asker C Scale.

On the other hand, the secondary transfer outer roller 64 has a metal core 64a serving as a conductive shaft portion and an elastic layer 64b serving as an outer portion. The elastic layer 64b includes conductive agent and is formed on an outer circumference of the metal core 64a. The secondary transfer outer roller 64 is configured by providing the elastic layer 64b, which is made of nitrile rubber (NBR) or EPDM containing conductive agent such as a metal complex or carbon, around the metal core 64a. The secondary transfer outer roller 64 is formed so that the roller diameter is 24 mm and the thickness of the elastic layer 64b, i.e., sponge layer, is 6 mm.

The power feed roller 68 is positioned in contact with an opposite side to the secondary transfer outer roller 64 with respect to the secondary transfer inner roller 62. More specifically, the power feed roller 68 is positioned to abut against the secondary transfer outer roller 64 at a position that is shifted by approximately 180° in the direction of rotation of the secondary transfer outer roller 64 with respect to an abutting position of the secondary transfer outer roller 64 against the intermediate transfer belt 56. The position of the power feed roller 68 may be any other position as long as the position is different from the abutting position of the secondary transfer outer roller 64 and the intermediate transfer belt 56.

The both ends of the power feed roller 68 in a rotation axial direction are pressed by springs (not illustrated) so that the power feed roller 68 abuts against the secondary transfer outer roller 64. In the present embodiment, a spring pressure for the power feed roller 68 is set to a total pressure of 500 gram-force (about 4.9 N). The high voltage power supply 120 supplies power to form an electric field used for the secondary transfer or various controls to the secondary transfer portion T2. In the present embodiment, a constant voltage power supply is used as the high voltage power supply 120.

In the image forming operation, the secondary transfer outer roller 64 rotates following the traveling of the intermediate transfer belt 56. Furthermore, the power feed roller 68 follows the rotational drive of the secondary transfer outer roller 64. After various controls are performed and when the recording material P is sent from the supply roller 66 to the secondary transfer portion T2, a secondary transfer bias having an opposite polarity to a normal charge polarity of the toner is applied to the power feed roller 68, in order to secondarily transfer the toner image formed on the intermediate transfer belt 56 onto the recording material P. In the present embodiment, since the toner has a negative charge polarity, a positive bias is applied as the secondary transfer bias.

### Power Feed Roller

Here, the power feed roller 68 will be described in detail. The power feed roller 68 has a configuration in which a metal roller of which an exemplary material is SUM or SUS, i.e., stainless steel, is coated with a conductive resin containing a conductive substance. A diameter of the metal roller is approximately 4 to 15 mm and a thickness of the conductive resin is 1 to 200 μm. If the diameter of the metal roller is smaller than that, deflection occurs when pressurized, which may cause that a voltage is not uniformly applied in a longitudinal direction (rotation axial direction), or that cracking or peeling of the conductive resin occurs. On the other hand, if the diameter of the metal roller is greater than that, the material cost increases, and the size and weight of the power feed roller 68 will increase. Therefore, it is preferable that the diameter of the metal roller is within the range described above.

Examples of the conductive substance contained in the conductive resin includes carbon black and carbon fiber. As a method of forming the conductive resin, the conductive substance described above is dissolved and dispersed in a suitable organic solvent to obtain a coating solution for a surface layer. Then, the coating solution is applied to the outer periphery of the metal roller by a method such as ring coating, dip coating, or spray coating, and drying is performed for the purpose of removing the organic solvent. Drying in an environment of approximately 30 to 60 degrees Celsius is desirable so as not to induce a radical reaction. Thereafter, ultraviolet ray curing is performed using an ultraviolet irradiation machine to obtain the power feed roller 68 described above. In the present embodiment, the metal roller of SUS having a diameter of 8 mm is coated with the conductive resin of 10 μm by dip coating. As the conductive resin, a material obtained by adding perfluoropolyether and zinc antimonate to acrylic resin is used.

### Cleaning Configuration of Power Feed Roller

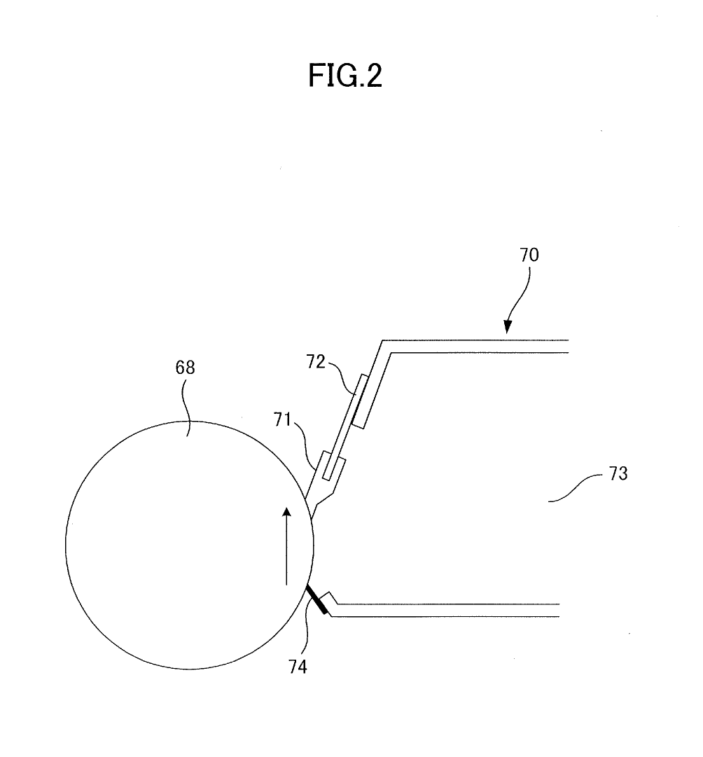

In the present embodiment, a roller cleaning unit 70 for cleaning the surface of the power feed roller 68 is provided. The roller cleaning unit 70 is of a so-called blade cleaning system using an elastic blade 71 as illustrated in FIG. 2. More specifically, the roller cleaning unit 70 includes the elastic blade 71 as a cleaning member, a support member 72, a collecting container 73, and a collecting sheet 74.

The elastic blade 71 is not particularly limited as long as it is an elastic body, and for example, fluororubber, EPDM or the like is used. In the present embodiment, the elastic blade 71 is made of polyurethane rubber, and abuts against the surface of the power feed roller 68 at a position different from the abutting position of the surface of the power feed roller 68 against the secondary transfer outer roller 64, in a so-called counter direction, with a contact angle of 130°. In FIG. 2, the power feed roller 68 rotates in a direction of an arrow and the elastic blade 71 extends so as to confront the direction of rotation. That is, at least a distal end portion of the elastic blade 71 abuts against the surface of the power feed roller 68, and at least a part of the abutting surface of the elastic blade 71 facing the surface of the power feed roller 68 is gradually separated from the surface of the power feed roller 68 along a downstream direction in the direction of rotation of the power feed roller 68.

In addition, the distal end portion of the elastic blade 71 abutting against the power feed roller 68 is extended along the rotation axial direction of the power feed roller 68, and a contact width of the elastic blade 71 in the longitudinal direction is equal to or greater than a width of the maximum image in the rotation axial direction capable of being formed on each photosensitive drum. In addition, an abutting pressure of the elastic blade 71 against the power feed roller 68 is regulated by setting spring pressure of the springs (not illustrated) to 200 gram-force (about 1.96 N), which are disposed at both end portions of the roller cleaning unit 70 in the longitudinal direction (rotation axial direction of the power feed roller 68).

A base end portion of the support member 72 is fixed to the collecting container 73 and the elastic blade is supported on the distal end portion thereof. Material of the support member 72 is not particularly limited, and an example thereof includes a rigid metal, an elastic metal, plastic, ceramic, or the like. For example, the support member 72 may be made of an untreated steel sheet, a steel sheet subjected to a surface treatment such as zinc phosphate treatment, or chromate treatment, or the like. In assembling the elastic blade 71, it is preferable to treat the support member 72 with a solvent to perform degreasing.

The collecting container 73 recovers the toner removed from the power feed roller 68 by the elastic blade along with the rotation of the power feed roller 68. Accordingly, a portion of the collecting container 73 facing the power feed roller 68 is opened, and the elastic blade 71 is supported on an upper portion of the opening portion via the support member 72. The collecting sheet 74 is supported at a lower portion of the opening portion of the collecting container 73, and the distal end portion thereof abuts against the power feed roller 68. With this configuration, the collecting sheet 74 receives the toner removed by the elastic blade 71 so as not to fall outside, and collects the toner in the collecting container 73. High Voltage Control of Secondary Transfer Portion

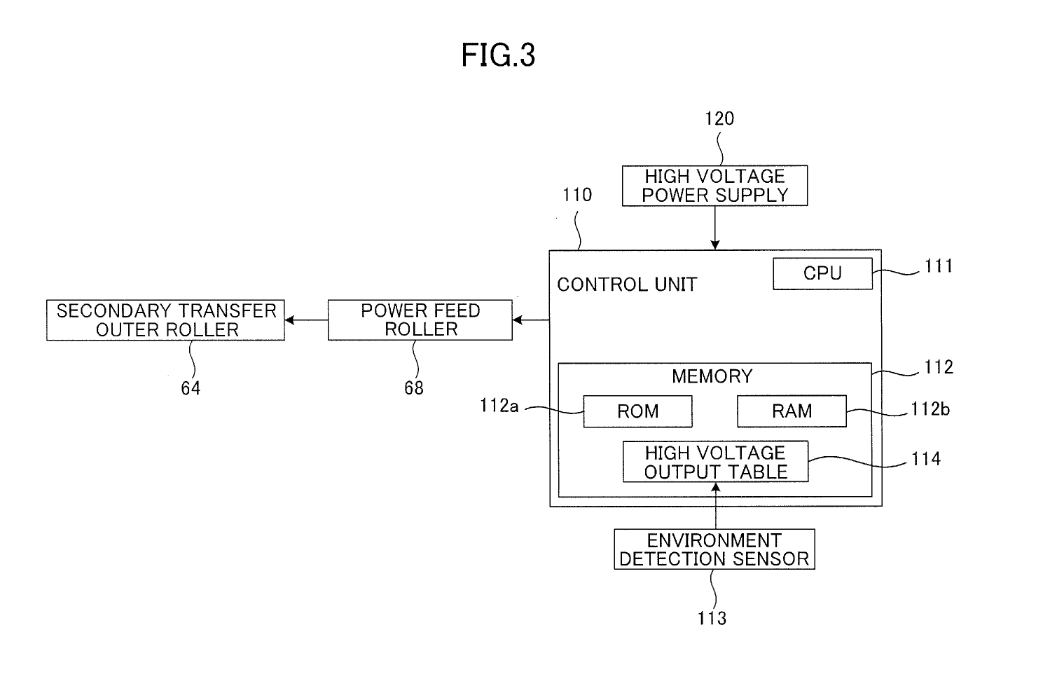

Next, an outline of a high voltage control of the secondary transfer portion will be described with reference to FIG. 3. The control unit 110 as control means, i.e., execution unit, is provided with a Central Processing Unit (CPU) 111 which performs the high voltage control. Furthermore, a Read Only Memory (ROM) 112a is provided in a memory 112. A program corresponding to a control procedure or the like is stored in the ROM 112a. The CPU 111 is adapted to control each portion while reading the program. In addition, the memory 112 also has a Random Access Memory (RAM) 112b in which operation data or input data is stored. The CPU 111 performs control with reference to data stored in the RAM 112b based on the program described above or the like.

In addition, the control unit 110 is connected to an environment detection sensor 113 which detects an environment condition such as a temperature or humidity inside the apparatus. The memory 112 stores a high voltage output table 114 that is a relationship between the temperature and humidity, and a voltage to be applied to the power feed roller 68. The high voltage power supply 120 is controlled by the CPU 111 with reference to the high voltage output table 114, and applies the secondary transfer bias or a transfer cleaning bias, which is described below, to the power feed roller 68.

### Secondary Transfer Cleaning Mode

The present embodiment is configured to execute a secondary transfer cleaning mode as an example of a cleaning mod. The secondary transfer cleaning mode, in which the transfer cleaning bias is applied to the power feed roller 68, is executed at a timing when the toner image is not transferred to the recording material at the secondary transfer portion T2. The timing of executing such a secondary transfer cleaning mode is after the completion of the jam process or after the execution of the adjustment mode such as toner concentration adjustment and toner image positional deviation adjustment. The jam process is, for example, a process for removing a jammed recording material in a case where a jam occurs in which the recording material is jammed in one of conveyance paths within the image forming apparatus during the image forming operation. In this case, there is a possibility that a jam occurs in a state where the toner image is placed on the intermediate transfer belt 56. After the jam process, a large amount of toner on the intermediate transfer belt 56 may adhere to the secondary transfer outer roller 64.

In addition, the present embodiment is, as illustrated in FIG. 1, provided with a detection sensor 57 as detection member configured to detect the toner image on the intermediate transfer belt 56, i.e., on the image bearing member. The detection sensor 57 is disposed at a position upstream of the secondary transfer portion T2 and downstream of image forming portions so as to face the surface of the intermediate transfer belt 56. In the adjustment mode, a patch image as an adjustment toner image is formed in each image forming portion, is transferred onto the intermediate transfer belt 56, and is detected by the detection sensor 57. Therefore, the image forming conditions such as the concentration adjustment of the toner image or the positional deviation of the toner image of each image forming portion are adjusted based on a detection result by the detection sensor 57. Since the patch image is not transferred to the recording material at the secondary transfer portion T2, a large amount of toner on the intermediate transfer belt 56 may adhere to the secondary transfer outer roller 64 after execution of such adjustment mode.

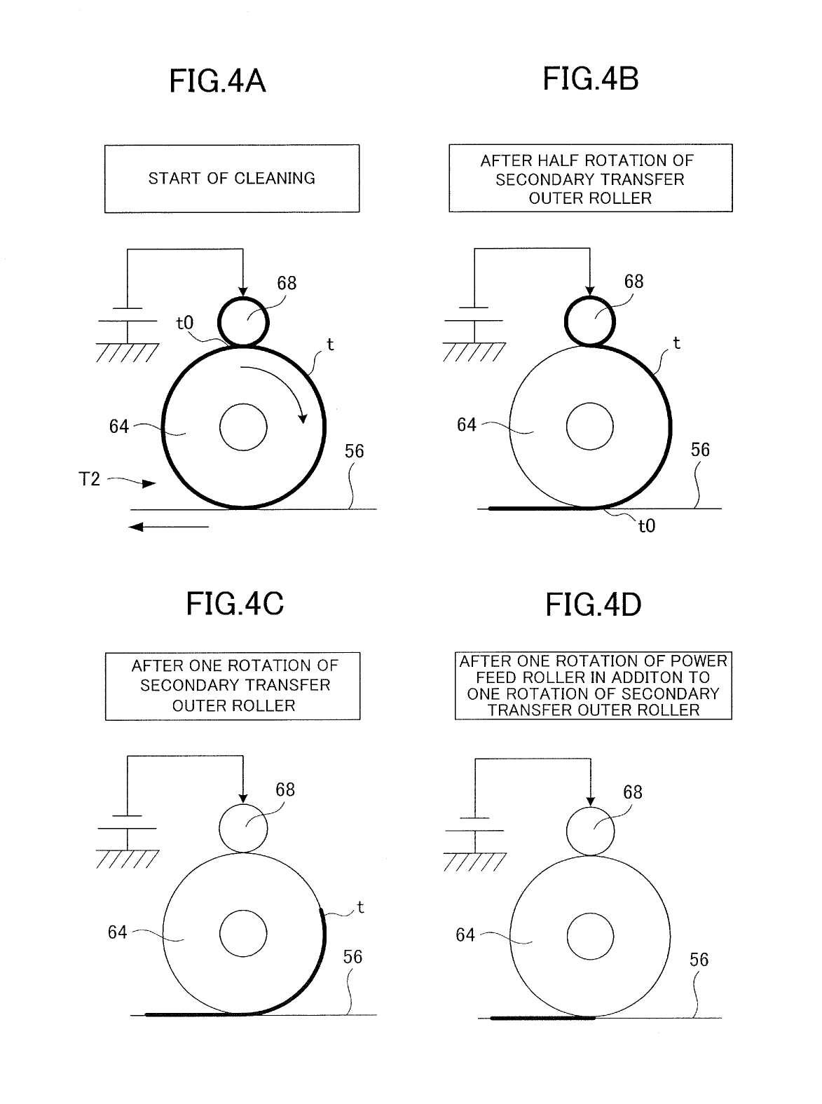

In any case, when a large amount of toner passes through the secondary transfer portion T2 without the recording material P, a large amount of toner adheres to the secondary transfer outer roller 64. This is because the toner passes through the secondary transfer portion T2 without the recording material P and toner adhesion is likely to occur on the secondary transfer outer roller 64. In a case where the next image forming process is performed while the toner having adhered on the secondary transfer outer roller 64, backside contamination may occurs, in which the toner adheres to a back surface of the recording material passing through the secondary transfer portion T2. Therefore, in a case where there is a possibility that a large amount of toner adheres to the secondary transfer outer roller 64, the control unit 110, i.e., execution unit, performs the secondary transfer cleaning mode for cleaning the toner having adhered to the secondary transfer outer roller 64. Before explaining the secondary transfer cleaning mode of the present embodiment, the secondary transfer cleaning mode of the comparative example will be described with reference to FIGS. 4A to 4D.

### Comparative Example

In a comparative example, a roller cleaning unit for cleaning the power feed roller 68 is not provided and the transfer cleaning bias is applied to the power feed roller 68 to clean the toner adhered to the secondary transfer outer roller 64. As illustrated in FIG. 4A, in a case where the secondary transfer outer roller 64 and the power feed roller 68 are contaminated with toner (pointed by “t”), the secondary transfer cleaning mode is executed. In addition, in the case of the comparative example, the power feed roller 68 is disposed so that an abutting position of the power feed roller 68 and the secondary transfer outer roller 64 is positioned at a position shifted by 180° with respect to an abutting position of the secondary transfer outer roller 64 and the intermediate transfer belt 56 in the direction of the rotation of the secondary transfer outer roller 64.

In the secondary transfer cleaning mode, the intermediate transfer belt 56 is rotationally driven. Then, the secondary transfer outer roller 64 and the power feed roller 68 are rotated. In this state, first, a voltage (transfer cleaning bias) having the same polarity, i.e., negative polarity, as the normal charge polarity of the toner is applied to the power feed roller 68, and whereby the toner t of negative polarity adhered to the secondary transfer outer roller 64 is transferred onto the intermediate transfer belt 56. In addition, the toner t adhered to the power feed roller 68 is transferred onto the secondary transfer outer roller 64 and then transferred further to the intermediate transfer belt 56 by applying the voltage.

FIG. 4B shows how toner adheres to the secondary transfer outer roller 64 and the power feed roller 68 after the secondary transfer outer roller 64 is half-turned. After the half rotation of the secondary transfer outer roller 64, the half of the secondary transfer outer roller is cleaned and the remaining half is in a state where the toner contamination remains. In addition, the toner contamination remains on the power feed roller 68 over the whole circumference.

This is because toner contamination occurs in both the secondary transfer outer roller 64 and the power feed roller 68 during the operation in FIGS. 4A to 4B. That is, during the secondary transfer outer roller 64 rotates by the half rotation, a voltage is applied between the power feed roller 68 and the secondary transfer outer roller 64 while the power feed roller 68 is in contact with the secondary transfer outer roller 64 causing toner contamination. Therefore, the voltage is applied in a state where a large amount of the toner existing in the nip portion between the secondary transfer outer roller 64 and the power feed roller 68. In such a case, a shortage of the voltage for moving the toner from the power feed roller to the secondary transfer outer roller 64 occurs, and the toner is unlikely to move from the power feed roller 68 to the secondary transfer outer roller 64.

In addition, due to the contact-friction between the secondary transfer outer roller 64 and the power feed roller 68, the toner on the secondary transfer outer roller may adhere to the power feed roller 68 with non-electrostatic adhesive force. Therefore, while the secondary transfer outer roller 64 rotates by the half rotation, the toner contamination is likely to remain on the entire circumference of the power feed roller 68. For this reason, cleaning of the power feed roller 68 is substantially started after the toner t0, which had been at an upstream position (FIG. 4A) from the abutting position of the secondary transfer outer roller 64 against the power feed roller 68 in the rotation direction of the secondary transfer outer roller 64 at the time when the voltage application is started, has moved to the intermediate transfer belt 56 (FIG. 4B). In the comparative example, cleaning of the power feed roller 68 is started after the half rotation of the secondary transfer outer roller 64.

FIG. 4C illustrates the remaining adhered toner on the secondary transfer outer roller 64 and the power feed roller 68 after the secondary transfer outer roller 64 has rotated once. In the operation of FIGS. 4B to 4C, the toner adhered to the power feed roller 68 is transferred onto the secondary transfer outer roller 64, and the power feed roller 68 is cleaned. Therefore, as illustrated in FIG. 4C, when cleaning is performed for one rotation of the secondary transfer outer roller 64, the toner t remains on the secondary transfer outer roller 64 over an area corresponding one round of the power feed roller 68.

Therefore, as illustrated in FIG. 4D, cleaning of a time of the one rotation of the power feed roller 68 from the state of FIG. 4C is further performed, as for the negatively charged toner, cleaning of both the secondary transfer outer roller and the power feed roller 68 can be completed. Therefore, in order to clean the toner charged to one of the negative polarity and the positive polarity, a cleaning time corresponding to one rotation of the power feed roller 68 is required in addition to a cleaning time corresponding to one rotation of the secondary transfer outer roller 64. The toner transferred onto the intermediate transfer belt 56 is cleaned by the belt cleaning unit 65.

Here, the toner adhered to the secondary transfer outer roller 64 and the power feed roller 68 is a mixture of toner that is electrically positively charged, i.e., positively charged toner, and toner that is negatively charged, i.e., negatively charged toner. That is, although the toner used for image forming process is basically charged to a negative polarity, the polarity of a part of the toner is reversed in some cases, since a voltage having an opposite polarity (positive polarity) to the normal charge polarity of the toner is applied as the secondary transfer bias at the secondary transfer portion T2.

Therefore, when the secondary transfer outer roller 64 and the power feed roller 68 are cleaned, the toner can be pulled back onto the intermediate transfer belt 56 by using this electric characteristic. More specifically, the positively charged toner is transferred onto the intermediate transfer belt 56 by applying a bias having a direction from the secondary transfer outer roller 64 to the secondary transfer inner roller 62, that is, by applying a voltage having the positive polarity to the secondary transfer outer roller 64. On the other hand, the negatively charged toner is transferred onto the intermediate transfer belt 56 by applying a bias having a direction from the secondary transfer inner roller 62 to the secondary transfer outer roller 64, that is, by applying a voltage having the negative polarity to the secondary transfer outer roller 64.

In this case, by making the secondary transfer outer roller 64 electrically floating, i.e., not connected to the Earth, biases in the same directions as that between the secondary transfer inner roller 62 and the secondary transfer outer roller 64 are applied between the secondary transfer outer roller 64 and the power feed roller 68. Therefore, it is possible to clean the secondary transfer outer roller 64 and the power feed roller 68 at the same time with one bias power supply.

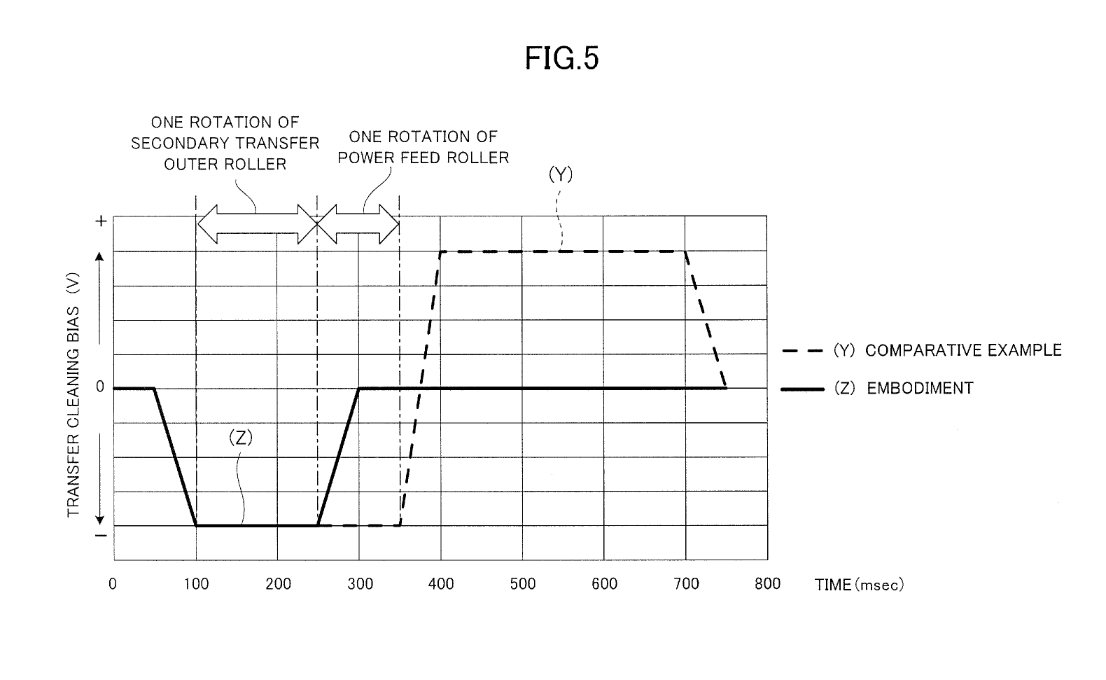

In the configuration of the comparative example, voltages of both polarities are applied as a transfer cleaning bias in order to clean the secondary transfer outer roller 64 and the power feed roller 68 to which the toner having both polarities is adhered. Therefore, as indicated by a broken line (Y) in FIG. 5, the application time of the transfer cleaning bias in the comparative example is a time twice a time obtained by adding the time of one rotation of the power feed roller 68 to the time of one rotation of the secondary transfer outer roller 64. More specifically, when the secondary transfer cleaning mode is started, a transfer cleaning bias having the negative polarity for a time corresponding to one rotation of the power feed roller 68 is applied in addition to one rotation of the secondary transfer outer roller 64, so that the negatively charged toner adhered to the secondary transfer outer roller 64 and the power feed roller 68 is removed. Next, the transfer cleaning bias having the positive polarity is applied for the same time, so that the positively charged toner adhered to the secondary transfer outer roller 64 and the power feed roller 68 is removed. As described above, in the case of the comparative example, since the voltages having both polarities are applied respectively for a time which obtained by adding one rotation of the power feed roller 68 to one rotation of the secondary transfer outer roller 64, a long time is required for cleaning the secondary transfer outer roller 64 and the power feed roller 68.

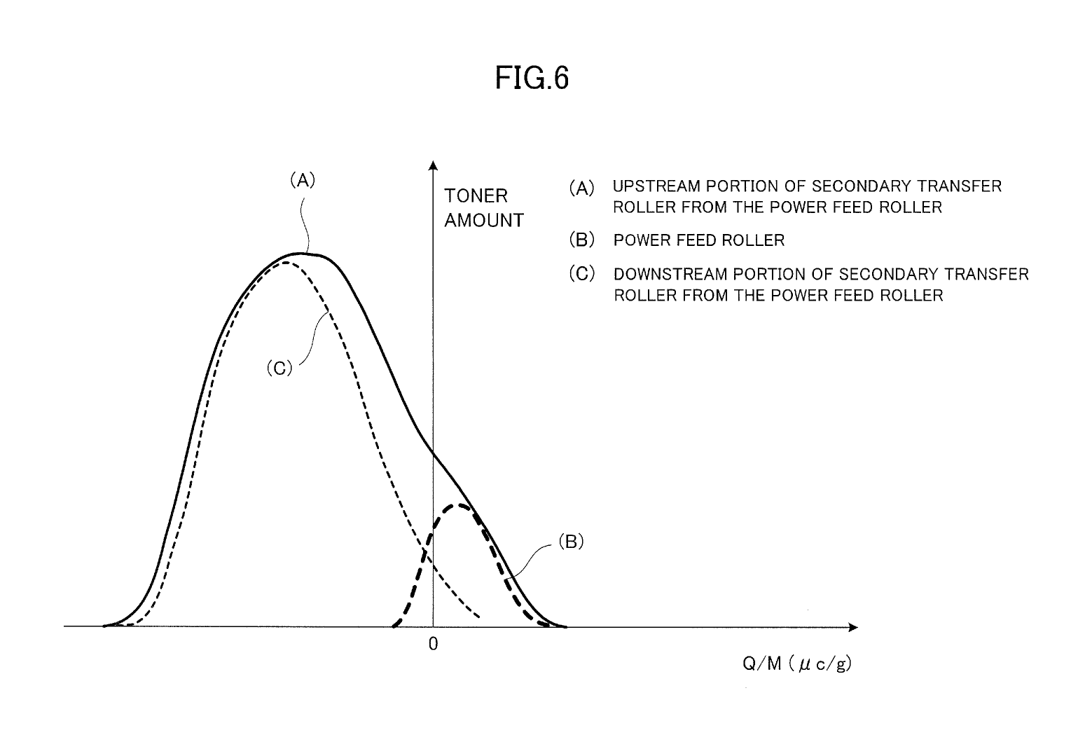

Here, it is known that the distribution of the charge amount of the toner adhered to the secondary transfer outer roller 64 and the power feed roller 68 is as illustrated in FIG. 6. In the secondary transfer portion T2, a bias having an opposite polarity to that of the toner is applied (for example, −1 μA) when a jam occurs or the like. In this case, the distribution of the toner adhered to an upstream portion, from the abutting position against the power feed roller 68, of the secondary transfer outer roller 64 is as indicated by the curve (A) in FIG. 6. That is, the distribution of the toner on the upstream portion from the power feed roller 68 of the secondary transfer outer roller 64 is composed of positively charged toner and negatively charged toner, which are respectively electrostatically and physically attracted from the intermediate transfer belt 56 to the secondary transfer outer roller 64.

In addition, in this case, the distribution of the toner adhered to the power feed roller 68 is as indicated by the curve (B) in FIG. 6. That is, the distribution of the toner of the power feed roller 68 is composed of positively charged toner and a small amount of negatively charged toner which are respectively electrostatically and physically attracted from the secondary transfer outer roller 64 to the power feed roller 68.

Further, in this case, the distribution of the toner adhered to the downstream portion, from the abutting position against the power feed roller 68, of the secondary transfer outer roller 64 is as indicated by the curve (C) in FIG. 6. That is, the distribution of the toner on the downstream portion of the power feed roller 68 of the secondary transfer outer roller 64 is composed of a small amount of the positively charged toner and the negatively charged toner remaining without being electrostatically attracted by the power feed roller 68.

In other words, in the upstream portion from the power feed roller 68 of the secondary transfer outer roller 64, it is in a state where positively and negatively charged toner is mixed (curve (A)). On the other hand, in the downstream portion from the power feed roller 68 of the secondary transfer outer roller 64, the negatively charged toner occupies a large amount (curve (C)). Further, on the power feed roller 68, it is in a state where positively charged toner occupies a large amount (curve (B)).

### Secondary Transfer Cleaning Mode in the Present Embodiment

Based on insights as described above, in the secondary transfer cleaning mode of the present embodiment, the high voltage power supply 120 applies only the voltage of one of the positive polarity and the negative polarity to the power feed roller 68 while the secondary transfer outer roller 64 and the power feed roller 68 are rotated. As described above, the execution of the secondary transfer cleaning mode is performed, for example, after completion of the jam process or after the execution of the adjustment mode and before the start of the next image formation, and in a period other than the period during which the toner image is transferred in the secondary transfer portion T2. For example, a transfer cleaning bias is applied to the power feed roller 68 after the completion of the jam process while rotating the photosensitive drum or the intermediate transfer belt without performing an image forming operation such as latent image formation. Otherwise, the secondary transfer cleaning mode may be executed at the time of pre-rotation upon starting an image forming job, at the time of post-rotation upon finishing the image forming job, or at the time of a paper interval after a predetermined number of images has been output.

It is noted that an image forming job is a period from the start of image forming operation based on a print signal that commands image forming on the recording material to the completion of the image forming operation. More specifically, it refers to a period which is from the pre-rotation after receiving the print signal (input of the image forming job) to the post-rotation, and which includes the image forming period and the paper interval (non-image formation) period. In addition, the pre-rotation is a period which is for preparatory operations before image forming process and in which the rotation of the photosensitive drum and the intermediate transfer belt is started, output of various voltages are sequentially started, and the various voltages are adjusted. The post-rotation is a period which is for operations after image formation and in which the various voltages are successively lowered while the rotation of the photosensitive drum and the intermediate transfer belt is continued, and finally the rotation of the photosensitive drum and the intermediate transfer belt is stopped. The paper interval is a period between the recording material and the recording material that sequentially pass through the secondary transfer portion T2.

In the present embodiment, during the execution of the secondary transfer cleaning mode, only voltage of one polarity is applied for a time that is equal to a time required for one rotation of the secondary transfer outer roller 64 or more and that is less than a time obtained by adding the time of one rotation of the power feed roller 68 to one rotation of the secondary transfer outer roller 64. More specifically, as indicated by a solid line (Z) in FIG. 5, a negative voltage having the same polarity as the normal charge polarity of the toner is adopted as a cleaning voltage and applied for a time corresponding to the one rotation of the secondary transfer outer roller 64.

In the present embodiment, since the roller cleaning unit 70 for cleaning the surface of the power feed roller 68 is provided, the toner adhered to the power feed roller 68 is removed by the roller cleaning unit 70. Therefore, it is possible to eliminate, or reduce at the least, the toner transferred from the power feed roller 68 to the secondary transfer outer roller 64. As described above, since the positively charged toner occupies a large amount in the adhered toner on the power feed roller 68, almost all of the positively charged toner adhered to the power feed roller 68 can be removed by the roller cleaning unit 70. Of course, the negatively charged toner attached to the power feed roller 68 can also be removed by the roller cleaning unit 70. It is noted that if the negatively charged toner slips through the roller cleaning unit 70, the negatively charged toner is transferred to the secondary transfer outer roller 64 by the application of the voltage described above and is transferred to the intermediate transfer belt 56 as follows.

Since the voltage having the negative polarity is applied to the secondary transfer outer roller 64 via the power feed roller 68, the negatively charged toner adhered to the secondary transfer outer roller 64 is transferred to the intermediate transfer belt 56 during one rotation of the secondary transfer outer roller 64. As described above, since the negatively charged toner occupies a large amount at the downstream portion of the power feed roller 68 of the secondary transfer outer roller 64, most of the toner is transferred from the secondary transfer outer roller 64 to the intermediate transfer belt 56. The toner transferred to the intermediate transfer belt 56 is cleaned by the belt cleaning unit 65.

Further, the positively charged toner at the upstream portion from the power feed roller 68 of the secondary transfer outer roller 64 is transferred to the power feed roller 68 by voltage application, and the toner transferred to the power feed roller 68 is then cleaned by the roller cleaning unit 70.

As described above, in the present embodiment, it is possible to perform cleaning of the secondary transfer outer roller 64 and the power feed roller 68 only by applying the voltage having one polarity as the transfer cleaning bias for a time required for one rotation of the secondary transfer outer roller 64. Therefore, the operation time of the secondary transfer cleaning mode is greatly shortened as compared with the comparative example. That is, it is possible to shorten the cleaning time of the secondary transfer outer roller 64 and the power feed roller 68.

Since secondary transfer cleaning mode is executed after the jam process or after the control mode, and before the next image formation is started, if the operation time of the secondary transfer cleaning mode is long, it takes time to start the next image forming process and causes decrease of the productivity of the image forming apparatus. In contrary, in the present embodiment, as described above, the operation time of the secondary transfer cleaning mode is shortened, and thereby the productivity can be improved.

### Second Embodiment

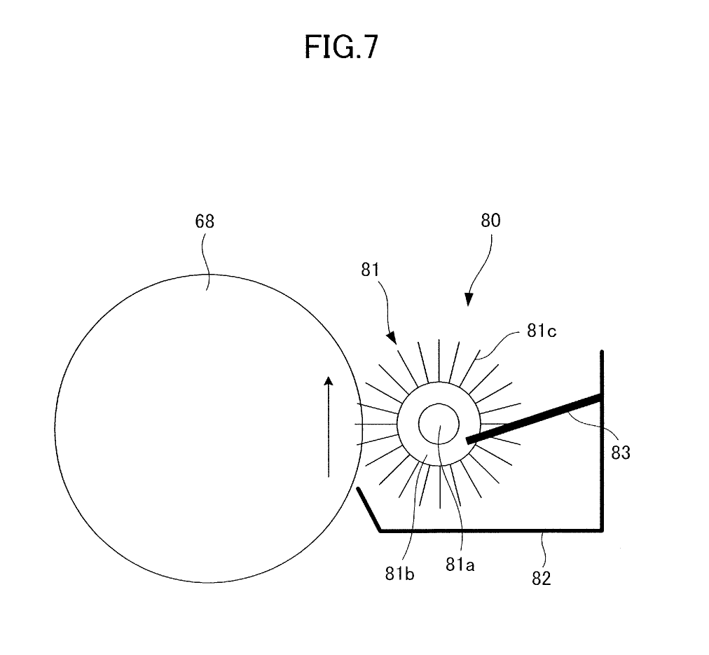

A second embodiment will be described with reference to FIG. 7. In the present embodiment, a cleaning member for cleaning a power feed roller 68 is a brush. Since other configurations and operations are the same as those of the first embodiment described above, portions different from the first embodiment will be mainly described below.

A roller cleaning unit 80 according to the present embodiment includes a brush 81 that rotates while rubbing a surface of the power feed roller 68, a collecting container 82, and a scraping plate 83. The brush 81 as a cleaning member is configured of a rotation shaft 81a, an elastic body layer 81b provided around the rotation shaft 81a, and a plurality of bristles 81c provided on an outer peripheral surface of the elastic body layer 81b. Both ends of the rotation shaft 81a are supported by the collecting container 82 so as to be substantially parallel to a rotation axis of the power feed roller 68, and the rotation shaft 81a is a shaft that is rotated by drive from a motor (not illustrated).

The elastic body layer 81b is a layer made of an elastic body formed substantially uniformly with a material for fixing the brush bristles 81c on the peripheral surface of the rotation shaft 81a. It is preferable that the elastic body layer 81b is a layer made of an elastic body having a hardness of 90 degrees (JIS A) or less and a thickness of 1 mm or more. In the present embodiment, a layer of natural rubber is used as the elastic body layer 81b.

It is preferable to use the brush bristles 81c that is harder than the elastic body layer 81b or brush bristles having the same hardness as the elastic body layer 81b. In the present embodiment, a diameter of the rotation shaft 81a is 6 mm, a thickness of the elastic body layer 81b is 2 mm and the elastic body layer 81b is uniformly provided around the rotation shaft 81a, and the brush bristles 81c are fixed to the elastic body layer 81b with a length of 5 mm.

The collecting container 82 collects the toner scraped off by the brush bristles 81c. In addition, the collecting container 82 supports the brush 81 so that a distance between the rotation axis of the brush 81 and the rotation axis of the power feed roller 68 becomes a predetermined distance (1.5 mm in the present embodiment).

The scraping plate 83 is disposed inside the collecting container 82 so that its tip enters the brush bristles 81c of the brush 81 and scrapes off the toner adhered to the brush bristles 81c into the collecting container 82. In the present embodiment, the scraping plate 83 is an elastic plate, and its tip elastically comes into contact with the surface of the elastic body layer 81b of the brush 81.

Such a roller cleaning unit 80 is rotated in the counterclockwise direction in FIG. 7 by the motor described above in a state where the brush bristles 81c is in contact with the power feed roller 68. That is, the brush 81 is rotated in a counter direction in which the direction of rotation is reversed at a position where the power feed roller 68 and the brush bristles 81c are in contact with each other.

As described above, the brush bristles 81c come into contact with the power feed roller 68, thereby scraping off the toner particles adhered onto the power feed roller 68 and cleaning the power feed roller 68. The toner entered a root portion of the brush bristles 81c of the brush 81 is scraped off when the brush bristles 81c come into contact with the scraping plate 83. Otherwise, the elastic body layer 81b fixing the brush bristles 81c is deformed by being in contact with the scraping plate 83 with the rotation of the brush 81, and the toner is discharged when the elastic deformation of the root portion of the brush bristles 81c is released. That is, a part of the elastic body layer 81b, which is elastically deformed by being in contact with the scraping plate 83, is deformed at the time of being elastically restored by slipping through the scraping plate 83 by rotation. Therefore, the toner intruded into the root portion of the brush bristles 81c is discharged.

Also in the case of the present embodiment, as similar to the first embodiment, the voltage having the negative polarity, the same polarity as the normal charge polarity of the toner, is applied to the power feed roller for a time required for one rotation of the secondary transfer outer roller 64 while rotating the brush 81 when the secondary transfer cleaning mode is executed. It is noted that when the secondary transfer cleaning mode is not being executed, the brush 81 may be driven by the rotation of the power feed roller 68 without being rotated by the motor.

### Other Embodiments

The image forming apparatus of the present disclosure is applicable to a copying machine, a printer, a facsimile, multi-function printer having multiple functions of these apparatuses, or the like.

Further, the cleaning member for cleaning the rotary power feed member may be anything other than using an elastic blade or a brush and as long as it can clean the rotary power feed member, that is, a cleaning roller may be used for example.

In addition, the transfer cleaning bias applied to the rotary power feed member in executing the secondary transfer cleaning mode may be opposite to the normal charge polarity of the toner. That is, in a case where the normal charge polarity of the toner is negative, a positive voltage may be adopted as a cleaning voltage and applied to the rotary power feed member.

In a case where a voltage of positive polarity, which is opposite to that of the toner, is applied, toner with reversed polarity (positively charged toner) is transferred to the intermediate transfer belt 56, and the toner having the same polarity as the charge polarity is transferred from the secondary transfer outer roller 64 to the power feed roller 68. Therefore, similarly to the above embodiments, it is possible to remove toners of both polarities in a short time. In short, the toner of one polarity is transferred to the intermediate transfer belt 56 and removed by the belt cleaning unit 65, the toner of the other polarity is transferred to the power feed roller and removed by the roller cleaning unit 70 or 80. Therefore, the secondary transfer portion T2 can be cleaned in a short time. Further, the time for applying the transfer cleaning bias may be longer than the time for the transfer roller to make one rotation.

Still further, similar to the secondary transfer outer roller, in the case where the primary transfer roller is formed as a roller having an elastic layer including a conductive agent at outer portion thereof, a power feed roller may be in contact with the primary transfer roller to apply a current. In this case, the photosensitive drum serves as an image bearing member. That is, the present disclosure is also applicable to a direct transfer system in which a toner image formed on a photosensitive drum is directly transferred to a recording material.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-111921, filed on Jun. 3, 2016, which is hereby incorporated by reference herein in its entirety.

What is claimed is:

1. An image forming apparatus comprising:
an image bearing member provided movable and configured to bear a toner image;
a transfer roller comprising a conductive shaft portion and an outer portion which is formed on an outer circumference of the shaft portion and which contains conductive agent, the transfer roller forming a transfer portion in which the toner image borne on the image bearing member is transferred to a recording material;
a rotary power feed member disposed in contact with the transfer roller and configured to feed a current to the transfer roller;
a power supply configured to apply voltage to the rotary power feed member;
a cleaning member disposed in contact with the rotary power feed member and configured to clean a surface of the rotary power feed member along with a rotation of the rotary power feed member; and
an execution unit configured to execute a cleaning mode in a period other than a period during which the toner image of the image bearing member is transferred to the recording material in the transfer portion, the power supply applying only a cleaning voltage to the rotary power feed member while the image bearing member is moved and the transfer roller and the rotary power feed member are rotated in the cleaning mode, a polarity of the cleaning voltage being the same polarity as a normal charge polarity of toner.

2. The image forming apparatus according to claim 1, wherein the execution unit executes the cleaning mode such that the power supply supplies the cleaning voltage for a time that is equal to or longer than a time required for one rotation of the transfer roller and that is less than a sum of the time required for one rotation of the transfer roller and a time required for one rotation of the rotary power feed member.

3. The image forming apparatus according to claim 1, wherein the execution unit is configured to execute the cleaning mode after a jam process has been finished and before a next image forming process is started.

4. The image forming apparatus according to claim 1, further comprising a detection member configured to detect the toner image borne on the image bearing member, wherein the execution unit is configured to execute an adjustment mode in which an adjustment toner image is formed on the image bearing member and an image forming condition is adjusted based on a result of detecting the adjustment toner image through the detection member, and the execution unit is configured to execute the cleaning mode after the adjustment mode has been finished and before a next image forming process is started.

5. The image forming apparatus according to claim 1, further comprising an image-bearing-member cleaning member configured to clean a surface of the image bearing member along with a movement of the image bearing member.

6. The image forming apparatus according to claim 1, wherein the cleaning member is a blade in contact with the surface of the rotary power feed member.

7. The image forming apparatus according to claim 1, wherein the cleaning member is a brush configured to rotate while rubbing the surface of the rotary power feed member.

8. An image forming apparatus comprising:
an image bearing member provided movable and configured to bear a toner image;
a transfer roller comprising a conductive shaft portion and an outer portion which is formed on an outer circumference of the shaft portion and which contains conductive agent, the transfer roller forming a transfer portion in which the toner image borne on the image bearing member is transferred to a recording material;
a rotary power feed member disposed in contact with the transfer roller and configured to feed a current to the transfer roller;
a power supply configured to apply voltage to the rotary power feed member;
a cleaning member disposed in contact with the rotary power feed member and configured to clean a surface of the rotary power feed member along with a rotation of the rotary power feed member; and
an execution unit configured to execute a cleaning mode in a period other than a period during which the toner image of the image bearing member is transferred to the recording material in the transfer portion, the power supply applying only a cleaning voltage to the rotary power feed member while the image bearing member is moved and the transfer roller and the rotary power feed member are rotated in the cleaning mode, a polarity of the cleaning voltage being an opposite polarity to a normal charge polarity of toner.

9. The image forming apparatus according to claim 8, wherein the execution unit executes the cleaning mode such that the power supply supplies the cleaning voltage for a time that is equal to or longer than a time required for one rotation of the transfer roller and that is less than a sum of the time required for one rotation of the transfer roller and a time required for one rotation of the rotary power feed member.

10. The image forming apparatus according to claim 8, wherein the execution unit is configured to execute the cleaning mode after a jam process has been finished and before a next image forming process is started.

11. The image forming apparatus according to claim 8, further comprising a detection member configured to detect the toner image borne on the image bearing member,
wherein the execution unit is configured to execute an adjustment mode in which an adjustment toner image is formed on the image bearing member and an image forming condition is adjusted based on a result of detecting the adjustment toner image through the detection member, and
the execution unit is configured to execute the cleaning mode after the adjustment mode has been finished and before a next image forming process is started.

12. The image forming apparatus according to claim 8, further comprising an image-bearing-member cleaning member configured to clean a surface of the image bearing member along with a movement of the image bearing member.

13. The image forming apparatus according to claim 8, wherein the cleaning member is a blade in contact with the surface of the rotary power feed member.

14. The image forming apparatus according to claim 8, wherein the cleaning member is a brush configured to rotate while rubbing the surface of the rotary power feed member.
